(19) United States
(12) Patent Application Publication
(10) Pub. No.: US 2022/0311644 A1
(43) Pub. Date: Sep. 29, 2022

(54) DATA TRANSMISSION METHOD AND DEVICE, ELECTRONIC APPARATUS AND STORAGE MEDIUM

(71) Applicant: BOE Technology Group Co., Ltd., Beijing (CN)

(72) Inventors: Rongzuo ZHANG, Beijing (CN); Tao LI, Beijing (CN); Jun YANG, Beijing (CN); Kui WU, Beijing (CN); Chao WU, Beijing (CN); Genyu LIU, Beijing (CN); Xingxing JIAO, Beijing (CN)

(21) Appl. No.: 17/502,976

(22) Filed: Oct. 15, 2021

(30) Foreign Application Priority Data
Mar. 24, 2021 (CN) 202110316370.6

(51) Int. Cl. H04L 12/66

(52) U.S. Cl. CPC H04L 12/66; G16Y 30/00

(57) ABSTRACT

A data transmission method and device, electronic apparatus and a storage medium provided by the disclosure are applied to the technical field of Internet of Things (IoT). The method comprises: receiving first underlying data sent by an IoT terminal; extracting part of data from the first underlying data as second underlying data according to parameter position information; converting the second underlying data into a target data format according to a format requirement corresponding to the parameter position information, so as to obtain third underlying data; and sending the third underlying data to an IoT server.

The present disclosure claims priority to Chinese Patent Application No. 202110316370.6 titled “DATA TRANSMISSION METHOD AND DEVICE, ELECTRONIC APPARATUS AND STORAGE MEDIUM” and filed to the State Patent Intellectual Property Office on Mar. 24, 2021, the entire contents of which are incorporated herein by reference.

### TECHNICAL FIELD

The disclosure belongs to the technical field of Internet of Things, and particularly relates to a data transmission method and device, an electronic apparatus and a storage medium.

### BACKGROUND

With the increasing popularization of the IoT technology, many enterprises have set about developing or already have their own IoT platforms. Protocols like HTTP (Hypertext Transfer Protocol) or MQTT (Message Queuing Telemetry Transport) are generally used for data transmission between an IoT platform and an IoT terminal. These protocols are highly readable and capable of meeting the requirements of IoT platforms for data transmission formats.

The situation that the IoT platform and the IoT terminal adopt the same transmission protocol is suitable for an apparatus directly connected with the IoT platform For apparatus featuring indirect connection, that is, IoT terminals connected with IoT platforms through gateway apparatus, such as some wireless apparatus activated at a certain time, they all use Bluetooth, Zigbee (a wireless network protocol for low-speed short-distance transmission) and other transmission methods to transmit data to IoT platforms through the gateway apparatus; and in this case, each frame of data only has dozens of to just over a hundred bytes.

### SUMMARY

The embodiments of the disclosure provide a data transmission method and device, electronic apparatus and a storage medium.

A first aspect of the disclosure provides a data transmission method applied to an gateway apparatus, the gateway apparatus is connected with an IoT server and an IoT terminal and stores a parameter correspondence between parameter position information and a format requirement, and the method comprises:

receiving first underlying data seat by the IoT terminal;

extracting part of data from the first underlying data as second underlying data according to the parameter position information;

converting the second underlying data into a target data format according to the format requirement corresponding to the parameter position information, so as to obtain third underlying data; and

sending the third underlying data to the IoT server.

Optionally, the parameter position information includes a parameter identifier and a parameter length, and extracting part of data from the first underlying data as second underlying data according to the parameter position information comprises:

querying a data field including the parameter identifier in the first underlying data; and

extracting part of data of the parameter length from a designated position in the data. field to obtain the second underlying data.

Optionally, extracting part of data of the parameter length from a designated position in the data field to obtain the second underlying data comprises:

extracting part of data of the parameter length from the parameter identifier in the data field to obtain the second underlying data.

Optionally, the format requirement at least comprises a parameter type, and converting the second underlying data into a target data format according to the format requirement corresponding to the parameter position information, to obtain third underlying data comprises:

converting the second underlying data into the parameter type to obtain a parameter value; and

combining the parameter identifier with the parameter value to obtain the third underlying data in the target data format.

Optionally, combining the parameter identifier with the parameter value to obtain the third underlying data in the target data format comprises:

replacing the second underlying data in the data field including the parameter identifier with the parameter value to obtain the third underlying data in the target data format.

A second aspect of the disclosure provides a gateway control method applied to an IoT server connected with an IoT terminal through a gateway apparatus, and the method comprises:

acquiring a parameter requirement in a target data format and acquiring parameter position information in a transmission protocol used by the IoT terminal;

establishing a parameter correspondence between the parameter position information and the parameter requirement to obtain a parameter conversion script including the parameter correspondence; and

sending the parameter conversion script to the gateway apparatus, the parameter conversion script being configured to control the gateway apparatus to execute the steps of any data transmission method in the first aspect according to the parameter correspondence.

A third aspect of the disclosure provides an electronic apparatus, comprising a processor, a memory, and a program or instruction stored on the memory and operable on the processor, and the program or instruction, when executed by the processor, implements the data transmission method in the first aspect.

A fourth aspect of the disclosure provides an electronic apparatus, comprising a processor, a memory, and a. program or instruction stored on the memory and operable on the processor, and the program or instruction, when executed by the processor, implements the gateway control method in the second aspect.

A fifth aspect of the application provides a computer non-transitory readable storage medium, a computer program is stored on the readable storage medium, and the computer program, when executed by a processor, implements the data transmission method in the first aspect.

A sixth aspect of the application provides a computer non-transitory readable storage medium, a computer program is stored on the readable storage medium, and the computer program, when executed by a processor, implements the gateway control method in the second aspect.

A seventh aspect of the application provides a computer program product, comprising a computer-readable code, wherein when the computer-readable code runs on an electronic apparatus, the electronic apparatus is caused to perform the data transmission method in the first aspect.

An eighth aspect of the application provides a computer program product, comprising a computer-readable code, wherein when the computer-readable code runs on an electronic apparatus, the electronic apparatus is caused to perform the gateway control method in the second aspect.

The above description is only an overview of the technical solution of this disclosure, which may be implemented according to the contents of the specification in order to understand the technical means of this disclosure more clearly, and in order to make the above and other objects, features and advantages of this disclosure more obvious and understandable, a detailed description of this disclosure will be given below.

### BRIEF DESCRIPTION OF THE DRAWINGS

Various other advantages and benefits of the invention will become apparent to those of ordinary skill in the art upon reading the following detailed description of preferred embodiments. The drawings are only for the purpose of illustrating preferred embodiments, and are not to be considered as limiting the disclosure. Furthermore, throughout the drawing, the same parts are denoted by the same reference numerals. In the drawings:

FIG. 1 is a flowchart of a data transmission method provided by an embodiment of the disclosure:

FIG. 2 is a flowchart of another data transmission method provided by an embodiment of the disclosure;

FIG. 3 is a data transmission flowchart of a data transmission method provided by an embodiment of the disclosure;

FIG. 4 is a flowchart of a gateway control method provided by an embodiment of the disclosure;

FIG. 5 is an effect diagram of a gateway control method provided by an embodiment of the disclosure;

FIG. 6 is a structural block diagram of a data. transmission device provided by an embodiment of the disclosure;

FIG. 7 is a structural block diagram of a gateway control device provided by an embodiment of the disclosure; and

FIG. 8 is a structural diagram of an electronic apparatus provided by an embodiment of the disclosure.

### DETAILED DESCRIPTION

Exemplary embodiments of the disclosure will be described in more detail below with reference to the accompanying drawings. Although the exemplary embodiments of the disclosure are shown in the drawings, it should be understood that the disclosure may be embodied in various forms and should not be limited by the embodiments set forth herein. On the contrary, these embodiments are provided to gain a more thorough understanding of the disclosure and to fully convey the scope of the disclosure to those skilled in the art.

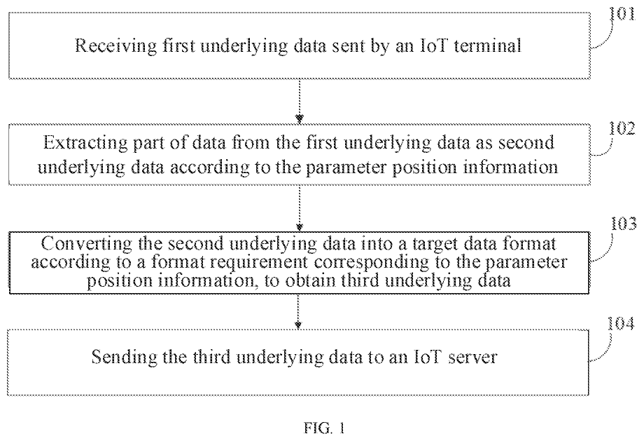

FIG. 1 is a flowchart of a data. transmission method provided by an embodiment of the disclosure, the method is applied to a gateway apparatus, the gateway apparatus is connected with an IoT server and an IoT terminal and stores a parameter correspondence between parameter position information and a format requirement, and the method comprises:

Step 101, receiving first underlying data sent by the IoT terminal.

In the embodiment of the disclosure, the IoT server is an electronic apparatus with data transmission, storage and processing functions, may be a server for collecting, analyzing and processing underlying data collected by the IoT terminal, and may also remotely control the IoT terminal. The IoT terminal refers to a terminal apparatus directly or indirectly connected with the IoT server to access the IoT, such as a Bluetooth speaker, an air conditioner, and a piece of intelligent furniture. It should be noted that the embodiment of this disclosure is mainly about the IoT terminal indirectly connected with the IoT server to solve its problem of low data transmission efficiency to the IoT server. The gateway apparatus is intermediate forwarding apparatus for forwarding the underlying data collected by the IoT terminal to the IoT server. Generally, gateway apparatus connected to a specific IoT terminal needs to be provided or configured by a provider of the specific IoT terminal so as to adapt to the specific IoT terminal. The first underlying data refer to the underlying data originally collected by the IoT terminal, which will be directly provided for the gateway apparatus and forwarded to the IoT server by the gateway apparatus.

The gateway apparatus may be provided with a format conversion script including the parameter correspondence between the parameter position information and the format requirement, It may be understood that because different IoT terminals adopt different data transmission formats, in order to make a data format of the provided IoT server uniform, the first underlying data provided by the IoT terminal may be subjected to data format conversion through the gateway apparatus. However, converting all the first underlying data into a data format such as JSON will increase the data size of the converted underlying data which is not conducive to data transmission. Therefore, in this embodiment of the disclosure, part of data in the first underlying data are converted based on the parameter correspondence to reduce the data size of the underlying data to be transmitted, and specific implementation will he described in detail below. The parameter correspondence may be preset in the gateway apparatus or provided by the IoT server for the gateway apparatus.

Step 102, extracting part of data from the first underlying data as second underlying data according to the parameter position information.

In the embodiment of the disclosure, the parameter position information is explanatory information for querying the second underlying data needed in the first underlying data, which may be a field location of the second underlying data in the first underlying data, or a query logic for querying the second underlying data in the first underlying data, such as the location information of a specific field in each frame of the underlying data, which may be set according to actual needs, and is not limited here. It should be noted that the second underlying data are only part of the first underlying data, so the data size of the second underlying data is smaller than that of the first underlying data. It may be understood that the first underlying data provided by the IoT terminal not only contain the values of collected parameters, but also contain information such as the apparatus label, collection time, accuracy, unit and range of the IoT terminal, but in fact, the IoT server may only need some of the values, even only the parameter values, so the data needed in the first underlying data may he located through the parameter position information, so that the data are extracted from the first underlying data and the data size in subsequent data format conversion is reduced.

Step 103, converting the second underlying data into a target data format according to the format requirement corresponding to the parameter position information, so as to obtain third underlying data.

In the embodiment of the disclosure, the format requirement is to convert a data transmission format used by the IoT terminal into a target data format used by the IoT server, and the format requirement may be generated based on a difference between the data transmission format of the IoT terminal and the target data format and provided for the gateway apparatus. By establishing the parameter correspondence between the parameter position information and the format requirement, part of data. required in the underlying data provided by the IoT terminal may be converted into the target data format required by the IoT server, thus ensuring a uniform format of the data received by the IoT server.

Step 104, sending the third underlying data to the IoT server.

In the embodiment of the disclosure, since the third underlying data are already in the target data format compatible with the IoT server, the gateway apparatus may directly send the obtained third underlying data to the IoT server. As the third underlying data are obtained by format conversion of only part of the first underlying data. provided by the IoT terminal, compared with the way of directly converting the first underlying data into the target data format, the size of data to be transmitted is greatly reduced, and the efficiency of collecting the underlying data in the IoT terminal by the IoT server is improved.

Specifically, a script may be generated and stored on the IoT server (e.g., cloud server, and background server) in advance, the script is a program for executing the steps of the data transmission method described in the embodiment of the disclosure, and the script may be automatically generated by the IoT server according to a transmission protocol between the gateway apparatus and a terminal apparatus and a transmission protocol adopted by the IoT server. The gateway apparatus may download the script from the cloud server, or the IoT server may issue the script to the gateway apparatus, so that the gateway apparatus may obtain and run the script, and setting the gateway apparatus on site by staff is not needed, which may reduce the workload required for configuring the gateway apparatus, and further reduce the workload required for indirectly connecting the IoT terminal with the IoT server through the gateway apparatus.

For example, when the IoT server adopts the JSON format, the IoT server may obtain the parameter position information of required parameter values according to the data. transmission protocol between the gateway apparatus and the IoT terminal, then establish a correspondence between the format requirement and the parameter position information corresponding to the parameter values according to the format requirement required by different parameter values in the JSON format to obtain the parameter correspondence, and finally update the parameter correspondence to a configuration file storing the parameter correspondence in the script, so that the script which needs to be deployed to the gateway apparatus connected with the IoT terminal is easily generated for downloading by the gateway apparatus or issuing by the IoT server. Of course, the data transmission protocols and data formats used by the IoT terminal, the gateway apparatus and the IoT server may be flexibly set according to actual needs. The script may be easily generated in the manner provided by the embodiment of the disclosure, so that the gateway apparatus may execute the steps in the data transmission solution described in the embodiment of the disclosure, allowing the IoT terminal to conveniently and efficiently upload the underlying parameters to the IoT server.

In the embodiment of the disclosure, by storing the parameter correspondence between the parameter position information and the format requirement in the gateway apparatus, the required part of data extracted from the underlying data provided by the IoT terminal according to the parameter position information are converted into the target data format according to the format requirement corresponding to the parameter position information, so as to be provided for the IoT server, thereby reducing the size of underlying data. that the gateway apparatus needs to send to the IoT server, and improving the efficiency of collecting the underlying data from the IoT terminal by the IoT server.

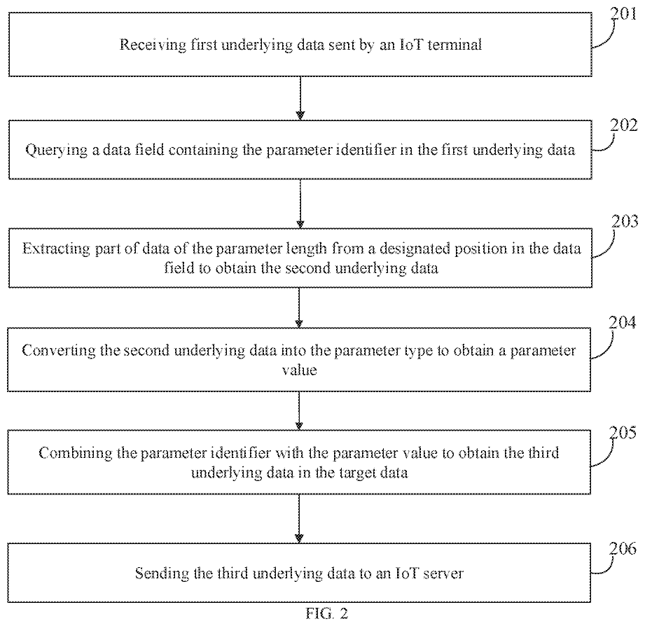

FIG. 2 is a flowchart of another data transmission method provided by an embodiment of the disclosure, the method is applied to a gateway apparatus, the gateway apparatus is connected with an IoT server and an IoT terminal and stores a parameter correspondence between parameter position information and a format requirement, and the method comprises:

Step 201, receiving first underlying data sent by the IoT terminal.

This step can be implemented with reference to the detailed description of step 101, which will not be repeated here.

Optionally, the parameter position information includes a parameter identifier and a parameter length.

Step 202, querying a data field including the parameter identifier in the first underlying data.

In the embodiment of the disclosure, the parameter identifier is a parameter code, a parameter name, etc. used to describe the content of a parameter, for example, the parameter identifier of time may he time, and the parameter identifier of distance may be distance, as long as the contents of the parameters can be distinguished by the parameter identifiers. In the first underlying data, all the data are arranged according to an underlying data format used, parameter markers marking data contents of the underlying data are generally contained, and data fields where the parameter markers are located contain the parameter values corresponding to the parameter markers, so the data field where each parameter marker is located may be queried first to determine the approximate location of the data to be extracted.

Step 203, extracting part of data of the parameter length from a designated position in the data field to obtain the second underlying data.

In the embodiment of the disclosure, the designated position refers to a field location of the parameter value corresponding to the parameter identifier in the data field. Generally, the designated position and the parameter length may be set based on the format rules of the underlying data protocol used by the IoT terminal. Because the position of the parameter value with respect to the parameter identifier and the parameter length in general underlying data formats are fixed or follow certain setting rules, the data required by the IoT server may be obtained by extracting the data of the parameter length at the designated position of the data field.

Optionally, step 203 may comprise: extracting part of data of the parameter length from the parameter identifier in the data field to obtain the second underlying data.

In the embodiment of the disclosure, since the parameter value corresponding to the parameter identifier is usually set after the parameter identifier, the required second underlying data may be efficiently extracted from the first underlying data by extracting part of the data of the parameter length after the parameter identifier.

Optionally, the format requirement at least includes a parameter type.

Step 204, converting the second underlying data into the parameter type to obtain a parameter value.

In the embodiment of the disclosure, because different data formats have different requirements for parameter types, in order to convert the second underlying data into the target data format, the second underlying data need to be converted according to the parameter type specified in the format requirement as parameter values of subsequently generated underlying data in the target data format.

Step 205, combining the parameter identifier with the parameter value to obtain the third underlying data in the target data format.

In the embodiment of the disclosure, in order to reduce the size of data to be transmitted as much as possible, the size of data contained in the third underlying data needs to be reduced. In the embodiment of the disclosure, the third underlying data in the target data format are obtained by combining only the parameter markers for marking parameter contents and the parameter values, so that the size of data transmitted from the gateway apparatus to the IoT server is greatly reduced.

Optionally, step 205 may comprise: replacing the second underlying data in the data to field including the parameter identifier with the parameter value to obtain the third underlying data in the target data format.

In the embodiment of the disclosure, if the data in the second underlying data have already been arranged according to the parameter identifier and the second underlying data, the data in the target data format do not need to be generated through recombination, and the third underlying data in the target data format may be efficiently obtained simply by changing the second underlying data in the extracted data field into the parameter values after parameter type conversion.

Step 206, sending the third underlying data to the IoT server.

This step can be implemented with reference to the detailed description of step 104, which will not be repeated here.

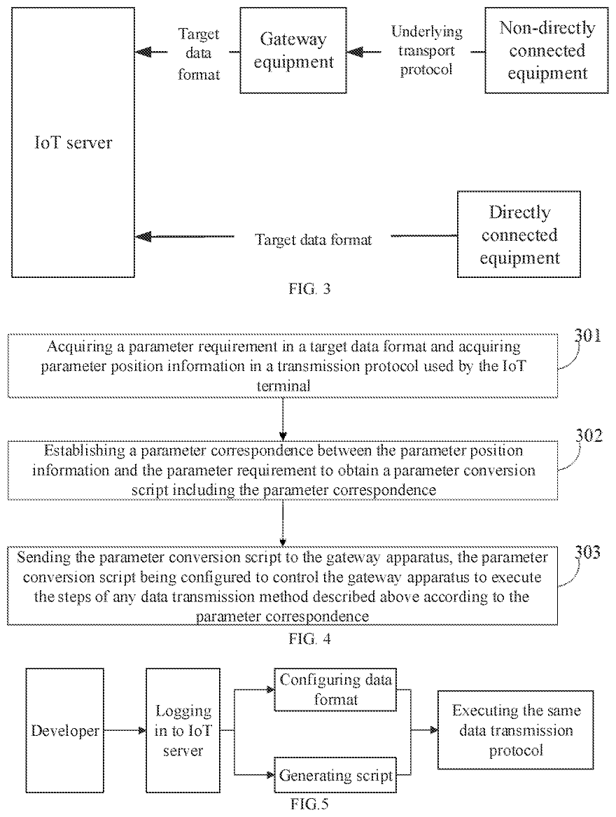

To facilitate understanding, refer to FIG. 3, in which both a non-directly connected apparatus and a directly connected apparatus are IoT terminals, but the directly connected apparatus is directly connected with the IoT server, while the non-directly connected apparatus is connected with the IoT server through the gateway apparatus. For example, an IoT terminal that transmits pH may upload pH to the IoT server regularly. If the IoT server adopts a JSON data format, completed information needs to be returned to the IoT server. Besides the parameter value of pH, package format, range, unit, accuracy, read-write property and other information needs to be returned. However, since the non-directly connected apparatus adopts a low-power underlying data transmission protocol, it takes a lot of time to transmit complete underlying data; In this case, the JSON format may be modified, and fields included in the JSON format may be set as a parameter identifier, a parameter length and a parameter type, these three parameter fields are mandatory, and other parameter fields may be set by users according to actual needs, thus ensuring that required data may be found in the underlying data provided by the IoT terminal through the parameter identifier and the parameter length, and the underlying data provided by the IoT terminal may be converted into the JSON format required by the IoT server according to a parameter format, so as to greatly reduce the size of the underlying data in the JSON format and improve the efficiency of collecting the underlying data from the IoT terminal by the IoT server.

In the embodiment of the disclosure, by storing the parameter correspondence between the parameter position information and the format requirement in the gateway apparatus, the required part of data extracted from the underlying data provided by the IoT terminal according to the parameter position information are converted into the target data format according. to the format requirement corresponding to the parameter position information, so as to be provided for the IoT server, thereby reducing the size of underlying data that the gateway apparatus needs to send to the IoT server, and improving the efficiency of collecting the underlying data from the IoT terminal by the IoT server.

FIG. 4 is a gateway control method provided by an embodiment of the disclosure, which is applied to an IoT server connected with an IoT terminal through gateway apparatus, and the method comprises:

Step 301, acquiring a parameter requirement in a target data format and acquiring parameter position information in a transmission protocol used by the IoT terminal.

In the embodiment of the disclosure, the IoT server takes a data structure and a. parameter requirement of the target data format as the parameter requirement, and acquires the parameter position information of a parameter value in the data structure in the data transmission protocol used by the IoT terminal. Of course, the parameter position information may be determined by configuring the underlying data transmission protocol used by the IoT terminal, or may be determined based on the original configuration of the underlying data transmission protocol.

Step 302, establishing a parameter correspondence between the parameter position information and the parameter requirement to obtain a parameter conversion script including the parameter correspondence.

In the embodiment of the disclosure, the IoT server establishes the parameter correspondence between the parameter position information and the parameter requirement and then sets it in a format conversion script to complete the development of the parameter conversion script.

Step 303, sending the parameter conversion script to the gateway apparatus, the parameter conversion script being configured to control the gateway apparatus to execute the steps of any data transmission method described above according to the parameter correspondence.

Referring to FIG. 5, a developer may log in to the IoT server to configure the target data format of the server, and then the format conversion script is adaptively generated to be issued to the IoT terminal, so that the IoT terminal may adopt the same data transmission protocol as the IoT server.

In the embodiment of the disclosure, the IoT server issues the format conversion script to the gateway apparatus, and after running the format conversion script, the gateway apparatus may start to acquire the underlying data from the IoT terminal, and send the underlying data to the IoT server based on any data transmission method described above.

In the embodiment of the disclosure, by storing the parameter correspondence between the parameter position information and the format requirement in the gateway apparatus, the required part of data extracted from the underlying data provided by the IoT terminal according to the parameter position information are converted into the target data format according to the format requirement corresponding to the parameter position information, so as to be provided for the IoT server, thereby reducing the size of underlying data that the gateway apparatus needs to send to the IoT server, and improving the efficiency of collecting the underlying data from the IoT terminal by the IoT server.

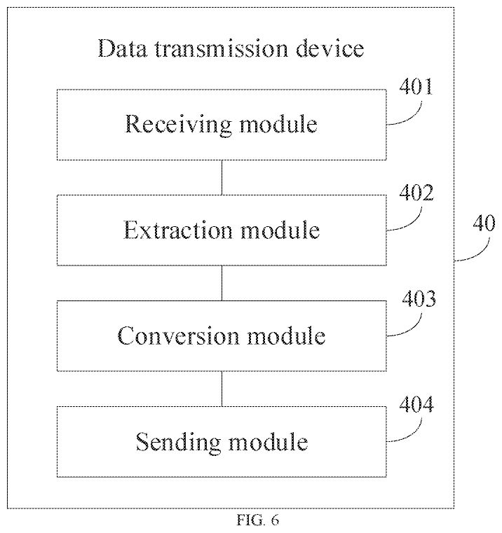

FIG. 6 is a structural block diagram of a data transmission device 40 provided by an embodiment of the disclosure, which is applied to gateway apparatus, the gateway apparatus is connected with an IoT server and an IoT terminal and stores a parameter correspondence between parameter position information and a format requirement, and the device comprises:

a receiving module 401 configured to receive first underlying data sent by the IoT terminal;

an extraction module 402 configured to extract part of data from the first underlying data as second underlying data according to the parameter position information;

a conversion module 403 configured to convert the second underlying data into a target data format according to the format requirements corresponding to the parameter position information, so as to obtain third underlying data; and

a sending module 404 configured to send the third underlying data to the IoT server.

Optionally, the parameter position information includes a parameter identifier and a parameter length, and the extraction module 402 is further configured to:

query a data field including the parameter identifier in the first underlying data; and

extract part of data of the parameter length from a designated position in the data field to obtain the second underlying data.

Optionally, the extraction module 402 is further configured to:

extract part of data of the parameter length from the parameter identifier in the parameter field to obtain the second underlying data.

Optionally, the format requirement at least includes a parameter type, and the conversion module 403 configured to:

convert the second underlying data into the parameter type to obtain a parameter value;

and

combine the parameter identifier with the parameter value to obtain the third underlying data in the target data format.

Optionally, the conversion module 403 is further configured to:

replace the second underlying data in the data field including the parameter identifier with the parameter value to obtain the third underlying data in the target data format.

In the embodiment of the disclosure, by storing the parameter correspondence between the parameter position information and the format requirement in the gateway apparatus, the required part of data extracted from the underlying data provided by the IoT terminal according to the parameter position information are converted into the target data format according to the format requirement corresponding to the parameter position information, so as to be provided for the IoT server, thereby reducing the size of underlying data that the gateway apparatus needs to send to the IoT server, and improving the efficiency of collecting the underlying data from the IoT terminal by the IoT server.

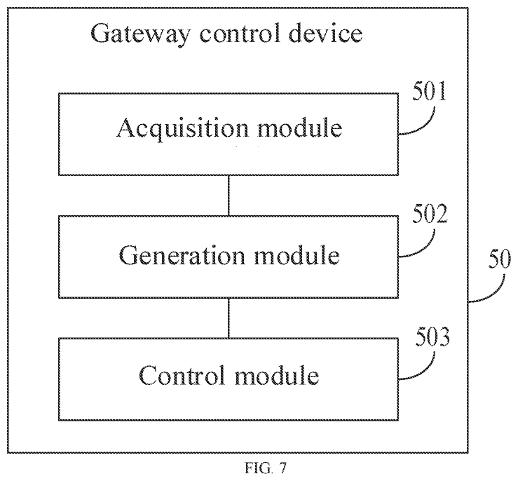

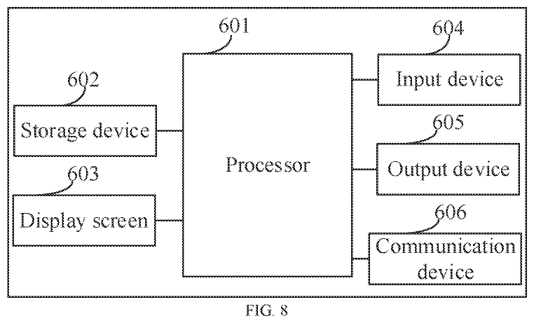

FIG. 7 is a structural block diagram of a gateway control device 50 provided by an embodiment of the disclosure, which is applied to an IoT server connected with an IoT terminal through a gateway apparatus, and the device comprises:

an acquisition module 501 configured to acquire a parameter requirement in a target data format and acquire parameter position information in a transmission protocol used by the IoT terminal;

a generation module 502 configured to establish a parameter correspondence between the parameter position information and the parameter requirement to obtain a parameter conversion script including the parameter correspondence; and

a control module 503 configured to send the parameter conversion script to the gateway apparatus, the parameter conversion script being configured to control the gateway apparatus to execute the steps of any data transmission method described above according to the parameter correspondence.

In the embodiment of the disclosure, by storing the parameter correspondence between the parameter position information and the format requirement in the gateway apparatus, the required part of data extracted from the underlying data provided by the IoT terminal according to the parameter position information are converted into the target data format according to the format requirement corresponding to the parameter position information, so as to be provided for the IoT server, thereby reducing the size of underlying data that the gateway apparatus needs to send to the IoT server, and improving the efficiency of collecting the underlying data from the IoT terminal by the IoT server.

In yet another embodiment provided by the disclosure, an electronic apparatus is provided, which may comprise a processor, a memory and a computer program stored in the memory and operable on the processor. When the processor executes the program, each process of the above data transmission method embodiment is realized and the same technical effect may be achieved, which will not be described in detail here to avoid repetition. For example, as shown in FIG. 8, the electronic apparatus may specifically comprise a processor 601, a storage device 602, a display screen 603 with a touch function, an input device 604, an output device 605 and a communication device 606. The number of the processors 601 in the electronic apparatus may be one or more, and one processor 601 is provided in FIG. 8 as an example. The processor 601, the storage device 602, the display screen 603, the input device 604, the output device 605 and the communication device 606 of the electronic apparatus may be connected by buses or other means.

In yet another embodiment provided by the disclosure, a computer non-transitory readable storage medium is provided, in which instructions are stored, which, When run on a computer, cause the computer to execute the data transmission method described in any one of the above embodiments.

In yet another embodiment provided by the disclosure, a computer program product including instructions is provided, which, when run on a computer, causes the computer to execute the data transmission method described in any one of the above embodiments.

It should be noted that herein, relational terms such as “first” and “second” are only used to distinguish one entity or operation from another entity or operation, and do not necessarily require or imply any such actual relationship or order between these entities or operations. The terms “comprise”, “include” or any other variations thereof, are intended to cover a non-exclusive inclusion, such that a process, method, article, or an apparatus which includes a list of elements does not include only those elements but also other elements not expressly listed or inherent to such process, method, article, or an apparatus. Without further limitation, an element defined by the statement “includes a ... ” does not exclude the presence of another identical element in a process, method, article or device that includes the element.

All the embodiments in this specification are described in a relevant manner, and the same and similar parts of different embodiments can serve as references for each other. Each embodiment focuses on its differences from other embodiments. As the system embodiments are basically similar to the method embodiments, the description of the system embodiments is relatively simple, and please refer to the description of the method embodiments for relevant information.

The above embodiments are only preferred ones of the disclosure and are not intended to limit the scope of protection of the disclosure. Any modifications, equivalent substitutions and. improvements made within the spirit and principles of the disclosure shall be included in the scope of protection of the disclosure.

1. A data transmission method, wherein the data transmission method is applied to a gateway apparatus, the gateway apparatus is connected with an IoT server and an IoT terminal and stores a parameter correspondence between parameter position information and a format requirement, and the method comprises:
receiving first underlying data sent by the IoT terminal:
extracting part of data from the first underlying data as second underlying data according to the parameter position information;
to converting the second underlying data into a target data format according to the format requirement corresponding to the parameter position information, to obtain third underlying data; and
sending the third underlying data to the IoT server.

2. The method according to claim 1, wherein the parameter position information includes a parameter identifier and a parameter length, and extracting part of data from the first underlying data as second underlying data according to the parameter position information comprises:
querying a data field including the parameter identifier in the first underlying data; and
extracting part of data of the parameter length from a designated position in the data field to obtain the second underlying data.

3. The method according to claim 2, wherein extracting part of data of the parameter length from a designated position in the data field to obtain the second underlying data comprises:
extracting part of data of the parameter length from the parameter identifier in the data field to obtain the second underlying data.

4. The method according to claim 2, wherein the format requirement at least includes a parameter type, and converting the second underlying data into a target data format according to the format requirement corresponding to the parameter position information, to obtain third underlying data comprises:
converting the second underlying data into the parameter type to obtain a parameter value; and
combining the parameter identifier with the parameter value to obtain the third underlying data in the target data format.

5. The method according to claim 4, wherein combining the parameter identifier with the parameter value to obtain the third underlying data in the target data format comprises:
replacing the second underlying data in the data field including the parameter identifier with the parameter value to obtain the third underlying data in the target data format.

6. A gateway control method, wherein the gateway control method is applied to an IoT server connected with an IoT terminal through gateway apparatus, and the method comprises:
acquiring a parameter requirement in a target data format and acquiring parameter position information in a transmission protocol used by the IoT terminal;
establishing a parameter correspondence between the parameter position information and the parameter requirement to obtain a parameter conversion script including the parameter correspondence; and
sending the parameter conversion script to the gateway apparatus, the parameter conversion script being configured to control the gateway apparatus to execute the steps of the data transmission method in claim 1 according to the parameter correspondence.

7. An electronic apparatus, comprising a processor, a memory, and a program or instruction stored on the memory and operable on the processor, wherein the program or instruction, when executed by the processor, implements operations comprising:
receiving first underlying data sent by an IoT terminal;
extracting part of data from the first underlying data as second underlying data according to parameter position information;
converting the second underlying data into a target data format according to the format requirement corresponding to the parameter position information, to obtain third underlying data; and
sending the third underlying data to the IoT server.

8. The electronic apparatus according to claim 7, wherein the parameter position information includes a parameter identifier and a parameter length, and extracting part of data from the first underlying data as second underlying data according to the parameter position information comprises:
querying a data field including the parameter identifier in the first underlying data; and
extracting part of data of the parameter length from a designated position in the data field to obtain the second underlying data.

9. The electronic apparatus according to claim 8, wherein extracting part of data of the parameter length from a designated position in the data field to obtain the second underlying data comprises:
extracting part of data of the parameter length from the parameter identifier in the data field to obtain the second underlying data.

10. The electronic apparatus according to claim 8, wherein the format requirement at least comprises a parameter type, and converting the second underlying data. into a target data format according to the format requirement corresponding to the parameter position information, to obtain third underlying data comprises:
converting the second underlying data into the parameter type to obtain a parameter value; and
combining the parameter identifier with the parameter value to obtain the third underlying data in the target data format.

11. The electronic apparatus according to claim 10, wherein combining the parameter identifier with the parameter value to obtain the third underlying data in the target data format comprises:
replacing the second underlying data in the data field including the parameter identifier with the parameter value to obtain the third underlying data in the target data format.

12. An electronic apparatus, comprising a processor, a memory, and a program or instruction stored on the memory and operable on the processor, wherein the program or instruction, when executed by the processor, implements the gateway control method according to claim 6.

13. A computer non-transitory readable storage medium, wherein a computer program is stored on the readable storage medium, and the computer program, when executed by a processor, implements operations comprising:
receiving first underlying data sent by an IoT terminal;
extracting part of data from the first underlying data as second underlying data according to parameter position information;
converting the second underlying data into a target data format according to the format requirement corresponding to the parameter position information, to obtain third underlying data; and
sending the third underlying data to the IoT server.

14. The storage medium according to claim 13, wherein the parameter position information includes a parameter identifier and a parameter length, and extracting part of data from the first underlying data as second underlying data according to the parameter position information comprises:
querying a data field including the parameter identifier in the first underlying data; and
extracting part of data of the parameter length from a designated position in the data field to obtain the second underlying data.

15. The storage medium according to claim 14, wherein extracting part of data of the parameter length from a designated position in the data field to obtain the second underlying data comprises:
extracting part of data of the parameter length from the parameter identifier in the data field to obtain the second underlying data.

16. The storage medium according to claim 14, wherein the format requirement at least comprises a parameter type, and converting. the second underlying data into a target data format according to the format requirement corresponding to the parameter position information, to obtain third underlying data comprises:
converting the second underlying data into the parameter type to obtain a parameter value; and
combining the parameter identifier with the parameter value to obtain the third underlying data in the target data format.

17. The storage medium according to claim 16, wherein combining the parameter identifier with the parameter value to obtain the third underlying data in the target data format comprises:
replacing the second underlying data in the data field including the parameter identifier with the parameter value to obtain the third underlying data in the target data format.

18. A computer non-transitory readable storage medium, wherein a computer program is stored on the readable storage medium, and the computer program, when executed by a processor, implements the gateway control method according to claim 6.

19. A computer program product, comprising a computer-readable code, wherein when the computer-readable code runs on an electronic apparatus, the electronic apparatus is caused to perform the data transmission method according to claim 1.

20. A computer program product, comprising a computer-readable code, wherein when the computer-readable code runs on an electronic apparatus, the electronic apparatus is caused to perform the gateway control method according to claim 6.
